(19) United States
(12) Patent Application Publication
(10) Pub. No.: US 2009/0207481 A1
(43) Pub. Date: Aug. 20, 2009

(54) Wavelength converter

(75) Inventor: Toshiaki Okuno, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 12/000,873

(22) Filed: Dec. 18, 2007

(30) Foreign Application Priority Data
Dec. 19, 2006 (JP) 2006-341644

(51) Int. Cl. G02F 1/35

(52) U.S. Cl. 359/332

(57) ABSTRACT

Provided is a wavelength converter capable of generating a converted signal having a wavelength different from the wavelength of input light. The wavelength converter of the present invention comprises: (1) a pump light source for outputting pump light; (2) a light multiplexing part for multiplexing the input light and the pump light and outputting thus multiplexed light; (3) and a plurality of optical fibers connected together in cascade, allowing the passage of the input light and the pump light thus multiplexed and output thereinto by the light multiplexing part, having mutually different zero dispersion wavelengths, and being capable of generating a converted signal by the nonlinear optical phenomenon occurring during the passage of the input light and the pump light. The wavelength conversion efficiency of the sidebands is less than −20 dB relative to the maximum value of the wavelength conversion efficiency in the entirety of the plurality of optical fibers.

### BACKGROUND OF THE INVENTION

1. Field of the Invention

The present invention relates to a wavelength converter which generates a converted signal having a wavelength different from the wavelength of the input light.

2. Description of the Background Art

Some of wavelength converters are such that they generate a converted signal having a wavelength different from the wavelength of input light, using nonlinear optical phenomenon (e.g., four-wave mixing or optical parametric oscillation) caused in an optical fiber. With respect to these wavelength converters, the wavelength band of input light that is a wavelength band including a pump light wavelength and that is capable of wavelength conversion (hereinafter, such wavelength band is referred to as the “main band”) has been discussed (For example, see Japanese Patent Application Publication No. H7-84289, or K. Inoue, Optics Lett., Vol. 19, No. 16 (1994) 1189). In the past discussions, wavelengths existing outside of the main band, which have been considered as unconvertible, have little been considered as an object for wavelength conversion.

Theoretically, however, the wavelength conversion efficiency shows periodic characteristics relative to input light (signal light) wavelength because the phase matching conditions in four-wave mixing and optical parametric oscillation stand periodically relative to wavelength difference Δλ. That is, within the main band, as the difference Δλ between the input light wavelength and the pump light wavelength increases, so the wavelength conversion efficiency gradually decreases. However, when the wavelength difference αλ increases more than within the main band, the wavelength conversion efficiency repeats alternate increase and decrease. Hereinafter, a band existing outside the main band and lying between two wavelengths where the wavelength conversion efficiency becomes minimal is each called a “sideband”, and of the sidebands, the wavelength band at which the wavelength difference Δλ is the smallest is called the “primary sideband”. In each sideband, the wavelength conversion efficiency becomes maximal at the wavelength of a wavelength difference Δλᵢ which is included in the sideband, and the wavelength conversion efficiency decreases as a wavelength is distanced from the wavelength of the wavelength difference Δλᵢ.

With a conventional wavelength converter, in spite of its intended use only for the wavelength conversion in the main band, there have been cases where wavelength conversion is done, due to the existence of a sideband, with respect to input light having a wavelength for which wavelength conversion is not intended. As a result, there has been a possibility that the degradation of original signal light occurs due to coherent crosstalk caused by the mutual interference of wavelength-converted light and the other light existing in the same wavelength field as the converted wavelength.

### SUMMARY OF THE INVENTION

An object of the present invention is to provide a wavelength converter in which the wavelength conversion of input light can be restrained with respect to the wavelength for which the wavelength conversion is not intended.

The wavelength converter relating to the present invention generates a converted signal having a wavelength different from the wavelength of input light, and comprises: (1) a pump light source for outputting pump light; (2) a light multiplexing part for multiplexing the input light and the pump light, and outputting thus multiplexed light; (3) and a plurality of optical fibers connected together in cascade, allowing the passage of the input light and the pump light which have thus been multiplexed and output thereinto by the light multiplexing part, having mutually different zero dispersion wavelengths, and being capable of generating a converted signal by the nonlinear optical phenomenon occurring during the passage of the input light and the pump light. Moreover, the wavelength conversion efficiency at sidebands of the wavelength converter relating to the present invention is less than −20 dB relative to the maximum value of the wavelength conversion efficiency in the entirety of the plurality of optical fibers.

In this wavelength converter, the input light that is an object of conversion is multiplexed by the light multiplexing part with the pump light output from the pump light source, and is input into one end of a plurality of optical fibers connected in cascade. While the input light and the input pump light pass through the plurality of optical fibers, the nonlinear optical phenomenon occurs such that a converted signal having a wavelength different from the wavelength of the input light is generated in the optical fibers. The converted signal generated in the plurality of optical fibers is output from the other end of the optical fibers. In such case, since the zero dispersion wavelengths of the optical fibers are different from each other and the wavelength conversion efficiency at the sidebands is less than −20 dB relative to the maximum value of the wavelength conversion efficiency in the entirety of the plurality of optical fibers, the maximum value of the wavelength conversion efficiency of the sidebands is suppressed to a small value with respect to the maximum value of the wavelength conversion efficiency in the main band. Thus, the wavelength conversion of input light having a wavelength for which the wavelength conversion is not intended can be restrained.

It is preferable the wavelength converter relating to the present invention be further equipped with a zero-dispersion wavelength adjusting means for adjusting the zero dispersion wavelength of any one of the plurality of optical fibers. In that case, the zero-dispersion wavelength adjusting means enables the plurality of optical fibers to have mutually different zero dispersion wavelengths even if the optical fibers are of the same kind.

The wavelength converter relating to the present invention preferably further comprises (a) a detecting part for detecting the conditions of the optical fibers and (b) a control unit for controlling the adjustment of zero dispersion wavelength of the optical fiber by the zero-dispersion wavelength adjusting means on the basis of the results of detection by the detecting part. In this case, the conditions of the optical fiber are detected by the detecting part, and based on the results of the detection by the detecting part, the control unit controls the zero dispersion wavelength adjustment of the optical fiber by the zero-dispersion wavelength adjusting means. In this manner, the wavelength conversion characteristics of the wavelength converter is not only adjusted but also stably maintained in the desired characteristics.

### BRIEF DESCRIPTION OF THE DRAWINGS

FIG. 1 is a graph showing the relationship between a wavelength difference Δλ and the wavelength conversion efficiency in Comparative Example.

FIG. 2 is a conceptional schematic diagram showing the respective arrangements of wavelengths of input light, pump light, and converted signals in the wavelength conversion of Comparative Example.

FIG. 3 is a conceptional schematic diagram of a wavelength converter relating to Embodiment 1 of the present invention.

FIG. 4 is a graph showing the relationship between a wavelength difference Δλ and the wavelength conversion efficiency in each of two optical fibers contained in the wavelength converter relating to Embodiment 1 of the present invention.

FIG. 5 is a graph showing the relationship between the wavelength conversion efficiency and a wavelength difference Δλ in the whole of two optical fibers contained in the wavelength converter relating to Embodiment 1.

FIG. 6 is a conceptional schematic diagram showing a concrete instance of zero-dispersion wavelength adjusting means contained in the wavelength converter relating to Embodiment 1.

FIG. 7 is a conceptional schematic diagram showing another concrete instance of zero-dispersion wavelength adjusting means contained in the wavelength converter relating to Embodiment 1.

FIG. 8 is a conceptional schematic diagram showing a further concrete instance of zero-dispersion wavelength adjusting means contained in the wavelength converter relating to Embodiment 1.

FIG. 9 is a conceptional schematic diagram showing still another concrete instance of zero-dispersion wavelength adjusting means contained in the wavelength converter relating to Embodiment 1.

FIG. 10 is a conceptional schematic diagram of the wavelength converter relating to Embodiment 2 of the present invention.

### DETAILED DESCRIPTION OF THE INVENTION

The above-mentioned features and other features, aspects, and advantages of the present invention will be better understood through the following description, appended claims, and accompanying drawings. In the explanation of the drawings, an identical mark is applied to identical elements and an overlapping explanation will be omitted.

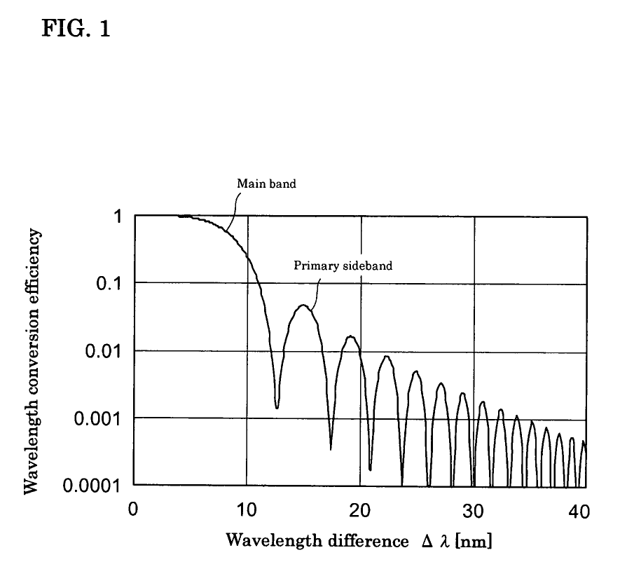

First, an explanation will be given with respect to the wavelength dependence of the wavelength conversion efficiency in the case of performing wavelength conversion using one optical fiber (Comparative Example). FIG. 1 is a graph showing the relationship between a wavelength difference Δλ and the wavelength conversion efficiency in Comparative Example. Here, it is assumed that the wavelength of the pump light is 1549.4 nm and that the optical fiber is a highly nonlinear fiber having the following specifications and the wavelength dependence of the dispersion slope as well as the zero dispersion wavelength is uniform in the longitudinal direction of the fiber.

| Items | Characteristic values | |
|---|---|---|
| Derivative $\frac{d {λ}_{0}}{dT}$ at pump light wavelength | 0.02 | nm/° C. |
| Chromatic dispersion | 0.024 | ps/nm/km |
| Dispersion slope | 0.03 | ps/nm²/km |
| Transmission loss | 0.5 | dB/km |
| Length | 2 | km |
| Nonlinear coefficient γ | 20 | W⁻¹ km⁻¹ |

In this optical fiber, the zero dispersion wavelength changes by just 0.8 according to the temperature variation of 40° C., because the value of derivative (dλ₀/dT) of zero dispersion wavelength λ₀ by temperature T is 0.02 nm/° C.

In FIG. 1, the wavelength difference Δλ at abscissa is a difference between the input light wavelength and the pump light wavelength. The wavelength conversion efficiency η of the ordinate is standardized with the wavelength conversion efficiency in the case where the input light wavelength and the pump light wavelength substantially agree with each other. In Comparative Example, in the range where the wavelength difference Δλ is 8.45 nm or less in the main band, the wavelength conversion efficiency of −3 dB or more can be obtained relative to the maximum value of the wavelength conversion efficiency. Also, sidebands exist outside the main band.

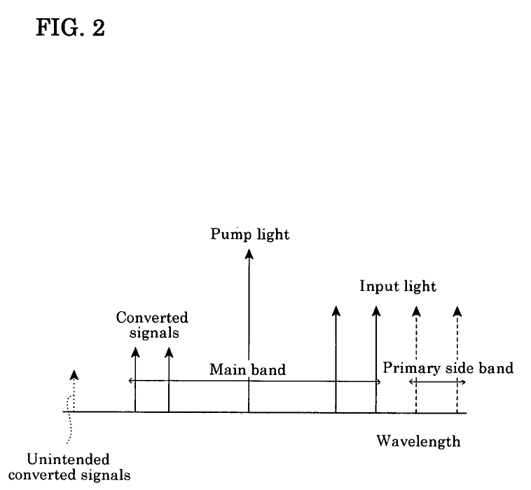

FIG. 2 is a conceptional schematic diagram showing the respective arrangements of wavelengths of input light, pump light, and converted signals in the wavelength conversion of Comparative Example. In the case of Comparative Example, input light having a wavelength which is comparatively near the pump light wavelength is caused to be a converted signal by wavelength conversion due to the contribution of the main band, and also the input light having a wavelength which is comparatively far from the pump light wavelength is made a converted signal by wavelength conversion due to the contribution of the primary sideband. Thus, the existence of the sideband causes wavelength conversion to the input light having the wavelength that is not intended to be subject to the wavelength conversion. On the other hand, in the case of the wavelength converter according to the following embodiment of the present invention, it is possible to restrain the wavelength conversion of input light having a wavelength that is not intended to be subject to wavelength conversion.

### Embodiment 1

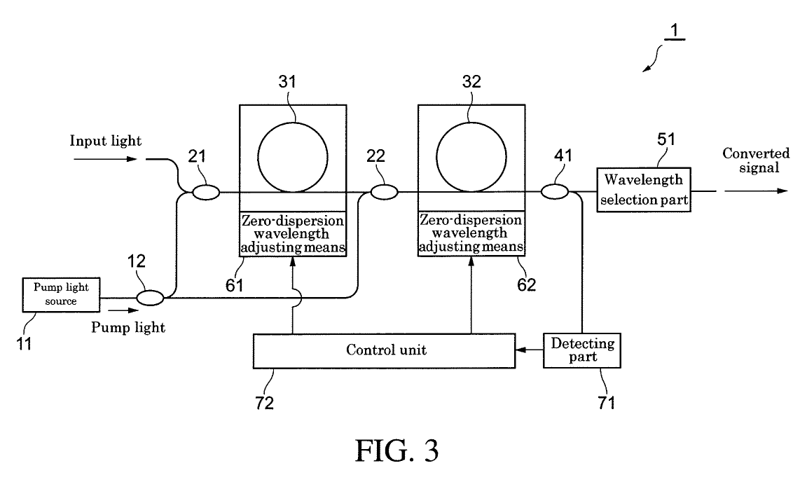

FIG. 3 is a conceptional schematic diagram of a wavelength converter relating to Embodiment 1 of the present invention. A wavelength converter 1 generates a converted signal having a wavelength different from the wavelength of the input light.

A pump light source 11 outputs pump light. A light splitting part 12 splits the pump light output from pump light source 11 into two and outputs the split pump light to light multiplexing parts 21 and 22. The light multiplexing part 21 receives and multiplexes the pump light that has reached from the light splitting part 12, as well as the input light that is an object to be converted, and outputs the multiplexed light into an optical fiber 31. Also, the light multiplexing part 22 receives and multiplexes the pump light that has reached from the light splitting part 12, as well as the light that has been output from the optical fiber 31, and outputs the multiplexed light into an optical fiber 32.

The optical fiber 31 receives the multiplexed input light and pump light at one end thereof and allows them to pass through it so as to generate a converted signal by the nonlinear optical phenomenon (four-wave mixing and optical parametric oscillation) that occurs during the passage thereof, and outputs the converted signal from the other end thereof to the light multiplexing part 22. Also, the optical fiber 32 receives, at one end thereof, the pump light and the light output from the optical fiber 31, allows them to pass therethrough, and generates a converted signal by the nonlinear optical phenomenon that occurs during the passage, so as to output the converted signal from the other end thereof into a light splitting part 41.

The optical fibers 31 and 32, which are connected in cascade with the light multiplexing part 22 put therebetween, have a zero dispersion wavelength near the pump light wavelength, but their zero dispersion wavelengths are different from each other. The light output from the other end of the optical fiber 32 includes, in addition to the converted signal light, light having the wavelength that is the same with the input light and the pump light.

Preferably, any one of the plurality of optical fibers (here, the optical fibers 31, 32) constituting the wavelength converter 1 is a highly nonlinear fiber. In that case, the wavelength conversion efficiency is higher and the optical fibers 31 and 32 can be made shorter. Therefore, the polarization mode dispersion, stimulated Brillouin scattering, and longitudinal variation of dispersion characteristics can be reduced. Also, it is preferable for the wavelength converter 1 to have a plurality of optical fibers (here, the optical fibers 31, 32) wound in a coil form. In such case, the downsizing is possible and the handling is easy.

The light splitting part 41 outputs most of the light received from the optical fiber 32 to a wavelength selection part 51, partially branching to output into a detecting part 71. The wavelength selection part 51 receives the light that has reached from the light splitting part 41, and outputs a converted signal selectively out of the input light. The wavelength selection part 51 is, for example, an optical filter, an optical demultiplexer, etc.

A zero-dispersion wavelength adjusting means 61 adjusts the zero dispersion wavelength of the optical fiber 31. A zero-dispersion wavelength adjusting means 62 adjusts the zero dispersion wavelength of the optical fiber 32. The zero-dispersion wavelength adjusting means 61 and 62 may adjust a zero dispersion wavelength by adjusting the temperature, stress, or tension of the optical fibers 31 and 32. When the zero-dispersion wavelength adjusting means 61 and 62 adjust the temperature of optical fibers 31 and 32, the temperature adjustment range is preferably equal to or more than 40° C. In that case, the quantity of wavelength converter adjustment of the wavelength conversion characteristics (the zero dispersion wavelength of the optical fibers 31, 32) can be made sufficient.

The optical fibers 31 and 32 may be of the same kind. Even if they are of the same kind, it is possible for them to have zero dispersion wavelengths that are mutually different as a result of their zero dispersion wavelengths being adjusted by the zero-dispersion wavelength adjusting means 61 and 62. Also, the optical fibers 31 and 32 may be of mutually different kind, having zero dispersion wavelengths different from each other at an identical temperature, and may have mutually different lengths. Also, the wavelength conversion efficiency at a sideband is less than −20 dB relative to the maximum value of the wavelength conversion efficiency in the entirety of the two optical fibers 31 and 32.

The detecting part 71, which receives the light that has been branched by the light splitting part 41 and has reached it, detects the conditions of the optical fibers 31 and 32 based on the results of the receipt of the light. In such case, the detecting part 71 detects the conditions of the optical fibers 31 and 32, based on the power or spectrum of the received light, or based on the power of the converted signal in the received light. A control unit 72 controls, based on the results of the detection by the detecting part 71, the zero dispersion wavelength adjustment of the optical fibers 31 and 32 performed by the zero-dispersion wavelength adjusting means 61 and 62.

The wavelength converter 1 operates as follows. The input light that is an object to be converted is multiplexed by the light multiplexing part 21 with the pump light that has been output from the pump light source 11 and branched by the light splitting part 12, and is input into one end of the optical fiber 31. Also, the light output from the other end of the optical fiber 31 is multiplexed by the light multiplexing part 22 with the other pump light, which has been output from the pump light source 11 and branched by the light splitting part 12, and is input into one end of the optical fiber 32. While the input light and the pump light pass through the optical fibers 31 and 32, the nonlinear optical phenomenon occurs such that the converted signal having a wavelength that is different from the wavelength of the input light is generated in the optical fibers 31 and 32. The converted signal generated in the optical fibers 31 and 32 is output from the other end of the optical fiber 32, and is output via the light splitting part 41 and the wavelength selection part 51.

In such case, the zero dispersion wavelength of the optical fiber 31 is adjusted by the zero-dispersion wavelength adjusting means 61, and also the zero dispersion wavelength of the optical fiber 32 is adjusted by the zero-dispersion wavelength adjusting means 62, so that the wavelength conversion characteristics in the wavelength converter 1 can also be adjusted accordingly. Also, the conditions of the optical fibers 31 and 32 are detected by the detecting part 71, and the zero dispersion wavelength adjustment of the optical fibers 31 and 32 by the zero-dispersion wavelength adjusting means 61 and 62 is controlled by the control unit 72, based on the results of the detection by the detecting part 71.

Here, the wavelength of the pump light is 1549.4 nm, and also the optical fiber 31 of 32 described in FIG. 1 are assumed to be a highly nonlinear fiber. By setting the temperature of the optical fiber 32 at 13° C. higher relative to the temperature of the optical fiber 31, the chromatic dispersion of the optical fiber 31 is 0.024 ps/nm/km and the chromatic dispersion of the optical fiber 32 is 0.0162 ps/nm/km at the pump light wavelength.

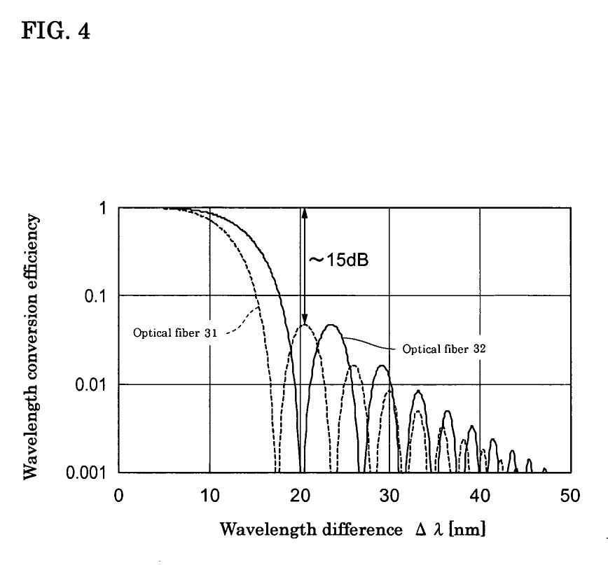

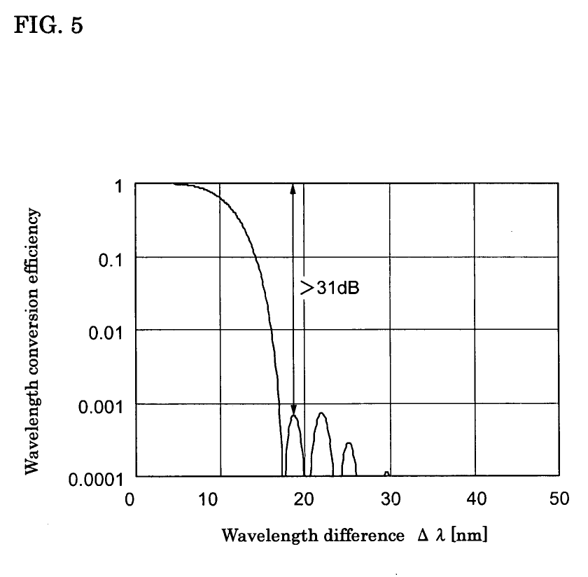

FIG. 4 is a graph showing the relationship between a wavelength difference Δλ and the wavelength conversion efficiency in each of two optical fibers 31 and 32, and FIG. 5 is a graph showing the relationship between the wavelength conversion efficiency and a wavelength difference Δλ in the whole of the two optical fibers 31 and 32. As shown in FIG. 4, with respect to the individual optical fibers 31 and 32, the maximum value of the wavelength conversion efficiency is about −15 dB at the primary sideband relative to the maximum value of the wavelength conversion efficiency in the main band. However, since the zero dispersion wavelength of the optical fiber 31 differs from that of the optical fiber 32, the wavelength dependence of the wavelength conversion efficiency in the optical fibers 31 and 32 is different from each other. Particularly, in this example, the wavelength at which the wavelength conversion efficiency becomes maximal at the primary sideband of the optical fiber 31 substantially agrees with the wavelength at which the wavelength conversion efficiency becomes minimal between the main band and the primary sideband of the optical fiber 32. As a result, as shown in FIG. 5, the maximum value of the wavelength conversion efficiency at sidebands is suppressed to −31 dB or less relative to the maximum value of the wavelength conversion efficiency in the main band with respect to the optical fibers 31 and 32 as a whole. Thus, the wavelength conversion of the input light can be restrained with respect to the wavelength that is not intend to be subject to the wavelength conversion.

Of course, such a simple multiplication of the conversion characteristics of the individual optical fibers does not always apply to actual cases. This is because the phases of three light, that is, signal light, converted signal, and pump light, are different at the time of being input into the optical fiber 32. In practice, therefore, minute adjustment must be made so as to optimize while monitoring with the control unit.

Particularly, it is preferable that the wavelength difference Δλ between the input light and the pump light where the wavelength conversion efficiency becomes equal to or more than −10 dB relative to the maximum value of the wavelength conversion efficiency at the main band be equal to or more than 15 nm in the entirety of the plurality of optical fibers (here, the two optical fibers 31 and 32) constituting the wavelength converter 1. That is, preferably the main bandwidth 2Δλ is 30 nm or more. In such case, the wavelength conversion of the input light can be achieved by the contribution of the main band with respect to all wavelengths included in the C-band.

Also, preferably the wavelength converter 1 is such that the wavelength λₚ of the pump light is less than 1570 nm, and the wavelength difference Δλ between the input light and the pump light where the wavelength conversion efficiency becomes equal to or more than −10 dB relative to the maximum value of the wavelength conversion efficiency is less than (1570 nm-λp) in the entirety of the plurality of optical fibers (here, the two optical fibers 31 and 32). By doing so, the wavelength conversion of the input light can be achieved by the contribution of the main band with respect to all wavelengths included in the C-band, and the wavelength conversion of the input light can be suppressed with respect to the wavelength included in the L-band.

Power of pump light introduced into the optical fibers 31 and/or 32 may be valuable and may be controlled, for example, by the multiplexing part 21 or 22 or a valuable attenuator disposed behind the multiplexing part 21 or 22. In addition, polarization state of the pump light introduced into the optical fibers 31 and/or 32 may be changeable. In these cases, conversion efficiencies in the optical fiber 31 and 32 can be independently controlled and flexibility of the wavelength converter increases. Therefore, the total conversion efficiency of the wavelength converter can be improved or maximized. More specifically, the total conversion efficiency with respect to the wavelength for which the wavelength conversion is intended can be increased while a sideband component is restrained. For example, even if polarization states of signal light and/or conversion light output from the optical fiber 31 vary, a malfunction such as decrease of conversion efficiency or insufficient sideband suppression can be avoided in a manner in which power of the pump light introduced into optical fiber 32 is increased or polarization state of the pump light is controlled.

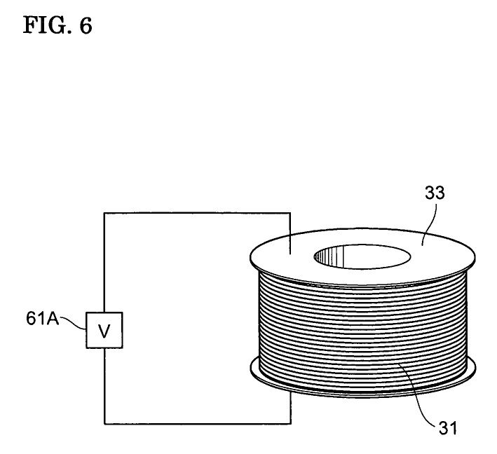

Next, an explanation will be given, using FIGS. 6 to 9, about the concrete structure of the zero-dispersion wavelength adjusting means 61 which is contained in the wavelength converter relating to Embodiment 1. In the structure shown in these figures, the optical fiber 31 is wound around in a coil form around the barrel of a bobbin 33. The zero-dispersion wavelength adjusting means 62 is the same as the zero dispersion wavelength adjusting means 61.

A voltage applying part 61A shown in FIG. 6 as a zero-dispersion wavelength adjusting means 61 is such that an electric current is caused by applying a voltage to a bobbin 33 so as to heat the optical fiber 31 as well as the bobbin 33 and thereby the zero dispersion wavelength of the optical fiber 31 is adjusted. Also, a heater and a Peltier element may be arranged at the bobbin 33 and the optical fiber 31 for the purpose of the zero-dispersion wavelength adjusting means 61, and thereby the zero dispersion wavelength of the optical fiber 31 may be adjusted.

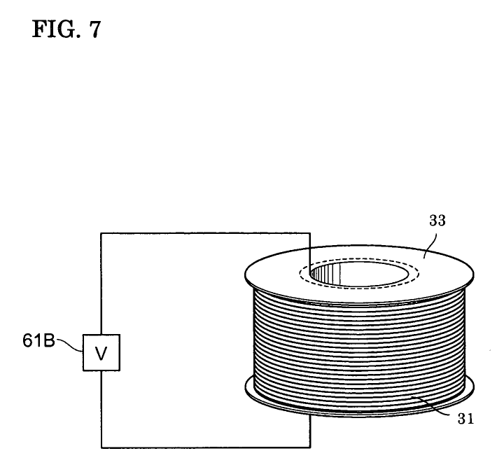

A voltage applying part 61B shown in FIG. 7 as the zero-dispersion wavelength adjusting means 61 is such that an electric current is caused by applying a voltage to the barrel part of the bobbin 33 so that the barrel part of the bobbin 33 may be expanded by the heat and the stress of the optical fiber 31 may be changed, and thereby the zero dispersion wavelength of the optical fiber 31 is adjusted.

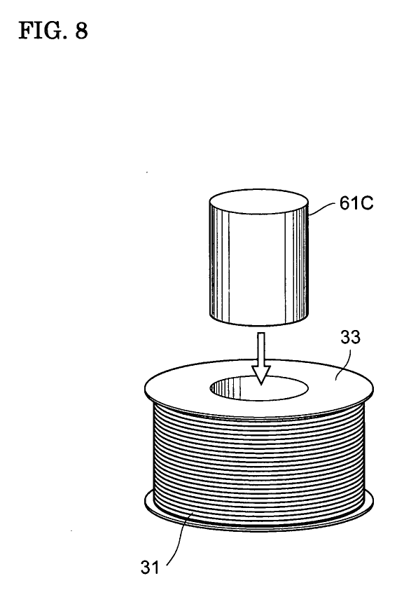

An elastic member 61C shown in FIG. 8 as the zero-dispersion wavelength adjusting means 61 has a columnar shape that can be inserted inside the barrel part of the bobbin 33 and can deform in a radial direction by means of a piezo-element, for example. The elastic member 61C changes the stress of the optical fiber 31 by the radial expansion and contraction thereof, and thereby adjusts the zero dispersion wavelength of the optical fiber 31. Also, the barrel part of the bobbin itself may be the piezo-element.

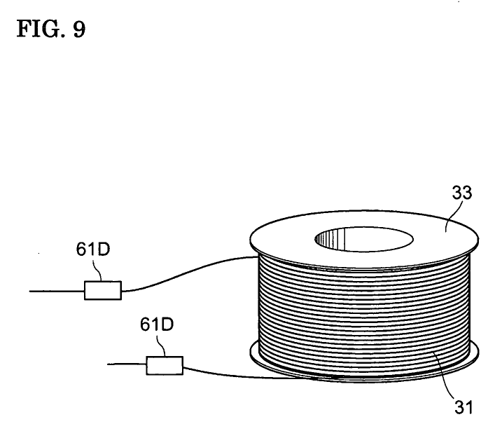

The tension applying parts 61D shown in FIG. 9 as the zero-dispersion wavelength adjusting means 61 are freely movable, holding both ends of the optical fiber 31 so as to adjust the zero dispersion wavelength of the optical fiber 31 by applying a tension to the optical fiber 31. The bobbin 33 may be turned so as to apply a tension to the optical fiber 31 and thereby the zero dispersion wavelength of the optical fiber 31 may be adjusted.

### Embodiment 2

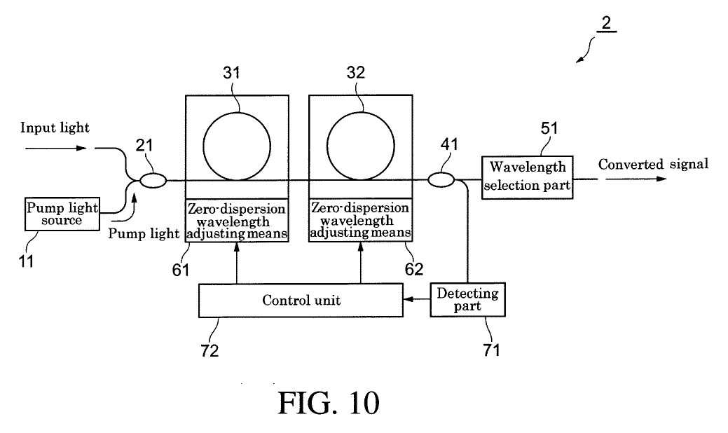

Next, a wavelength converter relating to a second embodiment of the present invention will be described. FIG. 10 is a conceptional schematic diagram of a wavelength converter 2 relating to Embodiment 2 of the present invention. The wavelength converter 2 generates a converted signal having a wavelength different from the wavelength of the input light. As compared with the structure of the wavelength converter 1 according to Embodiment 1 (FIG. 3), the wavelength converter 2 is different in that the light splitting part 12 and the light multiplexing part 22 are not provided and that the pump light output from the pump light source 11 travels, via the light multiplexing part 21, through the optical fiber 31 and the optical fiber 32 in the order.

The wavelength converter 2 works as follows. The input light that is an object to be converted is multiplexed by the light multiplexing part 21 with the pump light output from the pump light source 11 and is input into one end of the optical fiber 31. A converted signal having a wavelength different from the wavelength of the input light is generated in the optical fibers 31 and 32 by the nonlinear optical phenomenon that occurs while the input light and the pump light which have been input to the one end of the optical fiber 31 travel through the optical fibers 31 and 32. The converted signal generated in the optical fibers 31 and 32 is output from the other end of the optical fiber 32, and is output via the light splitting part 41 and the wavelength selection part 51.

In such case, the zero dispersion wavelength of the optical fiber 31 is adjusted by the zero-dispersion wavelength adjusting means 61, and also the zero dispersion wavelength of the optical fiber 32 is adjusted by zero-dispersion wavelength adjusting means 62. Accordingly, the wavelength conversion characteristics of the wavelength converter 2 can also be adjusted. Also, the conditions of the optical fibers 31 and 32 are detected by a detecting part 71, and the zero dispersion wavelength adjustment of the optical fibers 31 and 32 by the zero-dispersion wavelength adjusting means 61 and 62 are controlled by the control unit 72 based on the results of the detection made by the detecting part 71.

Since the zero dispersion wavelengths of the optical fibers 31 and 32 differ from each other in Embodiment 2 as in Embodiment 1, the respective wavelength dependence of the wavelength conversion efficiency in the optical fibers 31 and 32 are different from each other. Particularly, it is preferable that the wavelength where the wavelength conversion efficiency becomes maximal at the primary sideband of the optical fiber 31 substantially agree with the wavelength where the wavelength conversion efficiency becomes minimal between the main band and the primary sideband of the optical fiber 32. In such case, in the optical fibers 31 and 32 as a whole, the maximum value of the wavelength conversion efficiency at the sidebands is suppressed to a small value relative to the maximum value of the wavelength conversion efficiency in the main band. Thus, the wavelength conversion of the input light can be restrained with respect to the wavelength that is not intended to be subject to the wavelength conversion.

In Embodiment 2 also it is preferable that the wavelength difference Δλ between the input light and the pump light where the wavelength conversion efficiency becomes equal to or more than −10 dB relative to the maximum value of the wavelength conversion efficiency is equal to or more than 15 nm in the entirety of the two optical fibers 31 and 32. Also, preferably the wavelength λₚ of the pump light is less than 1570 nm, and the wavelength difference Δλ between the input light and the pump light where the wavelength conversion efficiency becomes equal to or more than −10 dB relative to the maximum value of the wavelength conversion efficiency is less than (1570 nm-λp) in the entirety of the two optical fibers 31 and 32.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims. For example, the optical fibers connected in cascade at the wavelength converter may be two as in the above-mentioned embodiments, or may be three or more. Also, in the wavelength converter of each embodiment, the back and forth relationship with respect to the optical fiber 31 and the optical fiber 32 may be optionally determined.

The entire disclosure of Japanese Patent Application No. filed on Dec. 19, 2006 including specification, claims, drawings, and summary are incorporated herein by reference in its entirety.

What is claimed is:

1. A wavelength converter for generating a converted signal having a wavelength that is different from the wavelength of input light, the wavelength converter comprising:
a pump light source for outputting pump light;
a light multiplexing part for outputting light by multiplexing the input light and the pump light; and
a plurality of optical fibers connected together in cascade and having mutually different zero dispersion wavelengths, the optical fibers being capable of generating a converted signal by the nonlinear optical phenomenon caused while the input light and the pump light that have been multiplexed and output by the light multiplexing part travel therethrough, wherein the wavelength conversion efficiency is less than −20 dB relative to the maximum value of the wavelength conversion efficiency at sidebands in the entirety of the plurality of optical fibers.

2. A wavelength converter as set forth in claim 1, wherein
any one of the plurality of optical fibers is a highly nonlinear fiber.

3. A wavelength converter as set forth in claim 1, wherein
the wavelength difference between the input light and the pump light where the wavelength conversion efficiency becomes equal to or more than −10 dB relative to the maximum value of the wavelength conversion efficiency is equal to or more than 15 nm in the entirety of the plurality of optical fibers.

4. A wavelength converter as set forth in claim 1, wherein
the wavelength λₚ of the pump light is less than 1570 nm, and the wavelength difference between the input light and the pump light where the wavelength conversion efficiency becomes equal to or more than −10 dB relative to the maximum value of the wavelength conversion efficiency is less than (1570 nm-λp) in the entirety of the plurality of optical fibers.

5. A wavelength converter as set forth in claim 1, wherein
the plurality of optical fibers are wound in a coil form.

6. A wavelength converter as set forth in claim 1, further comprising
a zero-dispersion wavelength adjusting means for adjusting the zero dispersion wavelength of any one of the plurality of optical fibers.

7. A wavelength converter as set forth in claim 6, wherein
the zero-dispersion wavelength adjusting means adjusts the zero dispersion wavelength by adjusting the temperature of the optical fibers.

8. A wavelength converter as set forth in claim 7, wherein
the temperature adjustment range by the zero-dispersion wavelength adjusting means is equal to or more than 40° C.

9. A wavelength converter as set forth in claim 6, wherein
the zero-dispersion wavelength adjusting means adjusts the zero dispersion wavelength by adjusting the stress of the optical fibers.

10. A wavelength converter as set forth in claim 6, wherein
the zero-dispersion wavelength adjusting means adjusts the zero dispersion wavelength by adjusting the tension of the optical fibers.

11. A wavelength converter as set forth in claim 6, the wavelength converter further comprising:
a detecting part for detecting the conditions of the optical fibers; and
a control unit for controlling the adjustment of zero dispersion wavelength of the optical fiber by the zero-dispersion wavelength adjusting means on the basis of the results of detection by the detecting part.
